(19) United States
(12) Patent Application Publication
(10) Pub. No.: US 2025/0304225 A1
(43) Pub. Date: Oct. 2, 2025

(54) CONTROL DEVICE FOR VESSEL FOR MANAGING VESSEL FUEL SYSTEM AND METHOD THEREOF

(71) Applicant: NOAH SBMA CO.,LTD., Busan (KR)

(72) Inventor: Samuel KIM, BUSAN (KR)

(21) Appl. No.: 18/552,876

(22) PCT Filed: May 16, 2023
(86) PCT No.: PCT/KR2023/006588

§ 371 Date: May 7, 2025

(30) Foreign Application Priority Data
Sep. 20, 2022 (KR) 10-2022-0118770

(51) Int. Cl. B63B 79/40; B63B 49/00; B63B 79/10; B63B 79/20; B63B 79/30; B63H 21/38

(52) U.S. Cl. CPC B63B 79/40; B63B 49/00; B63B 79/10; B63B 79/20; B63B 79/30; B63H 21/38; B63B 2203/00

(57) ABSTRACT

A control device for a vessel is disclosed. The device includes a universal interface that can be selectively connected to a plurality of sensors, a touch screen, a memory, and a processor. The processor is configured to, based on one of the plurality of sensors being connected to the universal interface and information on the connected sensor being input through the touch screen, control the touch screen to match and display a sensing value received through the universal interface and the input information, and diagnose a state of a system wherein the plurality of sensors are installed based on an artificial intelligence learning model stored in the memory and the sensing value.

### TECHNICAL FIELD

The disclosure relates to a control device for a vessel for managing a vessel fuel system, and a method thereof.

### DESCRIPTION OF THE RELATED ART

In a large vessel, various engines and components are used. An engine used in a vessel operates by using fuel appropriate for the vessel. Such fuel is generally called vessel oil. Vessel oil is generally stored in a fuel tank for preventing it from being volatilized or being contaminated as an external substance is introduced. Fuel stored in a fuel tank has a characteristic that it is hardened as its viscosity becomes higher when the temperature goes down to a specific temperature or lower. In case the viscosity becomes higher, it becomes difficult for the fuel to flow, and thus there is a possibility that the engine may be damaged due to this.

Accordingly, in a conventional vessel fuel system, various sensors are used for diagnosing the state of the fuel or other system states. Specifically, a viscosity sensor, a temperature sensor, a pressure sensor, a flow amount sensor, a chemical sensor, a level sensor, etc. may be used. Also, a controller is provided for each sensor, and performs a control operation based on the value of the sensor.

As a lot of sensors are used, there may be a case wherein some of them break down during the navigation of the vessel. Also, even if a sensor itself does not break down, in case a part of the system breaks down, a sensing value exceeding a normal range may be output from the sensor. In the conventional system, there was a problem that it was difficult to swiftly identify whether there was a breakdown in each sensor or the system, and even if a breakdown was identified, there could be a difficulty as there was no replacement part.

### DETAILED DESCRIPTION OF THE INVENTION

### Technical Task

The disclosure is for resolving the aforementioned problem, and the purpose of the disclosure is in providing a control device for a vessel that can swiftly and effectively diagnose whether there is a breakdown in a sensor or a system and can cope with the situation, and a method thereof.

Also, another purpose of the disclosure is in providing a control device for a vessel that can be generally used for various sensors used in a vessel fuel system, and can lengthen the lifespan of each sensor, and a method thereof.

### Technical Solution

A control device for a vessel according to one or more embodiments of the disclosure for achieving at least one of the aforementioned purposes of the disclosure includes a universal interface that can be selectively connected to a plurality of sensors, a touch screen, a memory, and a processor. Here, the processor is configured to, based on one of the plurality of sensors being connected to the universal interface and information on the connected sensor being input through the touch screen, control the touch screen to match and display a sensing value received through the universal interface and the input information, and diagnose a state of a system wherein the plurality of sensors are installed based on an artificial intelligence learning model stored in the memory and the sensing value.

Also, the universal interface may include a first universal interface and a second universal interface, and the processor may, based on a main sensor being connected to the first universal interface and a subsidiary sensor being connected to the second universal interface, alternately open or close a first fuel inlet valve for a first flow channel wherein the main sensor is arranged and a second fuel inlet valve for a second flow channel wherein the subsidiary sensor is arranged, and alternately use the main sensor and the subsidiary sensor.

Alternatively, the universal interface may include a first universal interface and a second universal interface, and the processor may, in a state wherein a main sensor is connected to the first universal interface and a subsidiary sensor is connected to the second universal interface, according to the number of times of touches of a menu on the touch screen, operate in one mode among a first operation mode of using the main sensor, a second operation mode of using the subsidiary sensor, or an AI mode of alternately using the main sensor and the subsidiary sensor according to a predetermined condition.

Also, the processor may, while operating in a first operation mode of using the main sensor, based on a sensing value of the main sensor being maintained within a specific numerical range during a predetermined time, automatically convert to a second operation mode of using the subsidiary sensor, and while operating in the second operation mode, based on a sensing value of the subsidiary sensor changing to exceed a predetermined change rate, automatically convert to the first operation mode.

In addition, the processor may operate in a first operation mode of using the main sensor during a training section of training the artificial intelligence learning model, and based on the training section being completed, automatically convert to a second operation mode of using the subsidiary sensor.

Further, the memory may store association data among sensing items of each of the plurality of sensors, the universal interface may include a first universal interface and a second universal interface, and the processor may, based on information on a first sensor connected to the first universal interface and a second sensor connected to the second universal interface being respectively input through the touch screen, identify the association data between the sensing item of the first sensor and the sensing item of the second sensor from the memory.

Also, the processor may alternately perform a first operation mode of controlling an external valve based on a first sensing value input from the first sensor and a second operation mode of assuming the first sensing value from a second sensing value input from the second sensor and the identified association data and controlling the external valve based on the assumed first sensing value.

In addition, the processor may, based on a change rate of the second sensing value exceeding a predetermined standard change rate while performing the second operation mode, automatically convert to the first operation mode.

Further, the memory may store association data among sensing items of each of the plurality of sensors, and the processor may, based on at least two sensors among the plurality of sensors being sequentially connected to the universal interface, identify association data on sensor items of each sensor from the memory, and diagnose whether there is a breakdown in each of the at least two sensors based on the association data.

Also, the control device for a vessel may further include an output interface that can be connected to a plurality of external valves, and the processor may output an output signal in a form corresponding to the type of the sensor connected to the universal interface through the output interface, and the output signal may be one of a voltage control signal, a current control signal, or a pressure control signal.

In addition, the memory may store association data among sensing items of each of the plurality of sensors and information on a plurality of coping solutions corresponding to sensor breakdown and system breakdown states, and the processor may, based on a sensor value of a sensor connected to the universal interface among the plurality of sensors, diagnose whether there is a breakdown in the connected sensor or a system area wherein the sensor is installed, and based on determining that there is a breakdown, perform a control operation based on coping solution information corresponding to the area of the breakdown.

Further, the processor may, based on determining that there is a breakdown in the connected sensor, display the types of sensors that can replace the connected sensor on the touch screen, and based on a replacement sensor being connected to the universal interface, assume a sensor value of the sensor that broke down from a sensor value of the replacement sensor based on the association data stored in the memory, and display the sensor value on the touch screen.

Meanwhile, according to one or more embodiments of the disclosure, a control method of a control device for a vessel including a plurality of universal interfaces that can be selectively connected to a plurality of sensors includes the steps of, based on a first sensor which is one of the plurality of sensors being connected to a first universal interface and information on the first sensor being input through a touch screen, matching and displaying a first sensing value received through the first universal interface and the input information, based on a second sensor which is one of the plurality of sensors being connected to a second universal interface and information on the second sensor being input through the touch screen, matching and storing a second sensing value received through the second universal interface and the information input regarding the second sensor, and alternately opening or closing a first fuel inlet valve for a first flow channel wherein the first sensor is arranged and a second fuel inlet valve for a second flow channel wherein the second sensor is arranged, and alternately using the first sensor and the second sensor.

Alternatively, the control method may further include the steps of, while operating in a first operation mode of using the first sensor, based on a sensing value of the first sensor being maintained within a specific numerical range during a predetermined time, automatically converting to a second operation mode of using the second sensor, and while operating in the second operation mode, based on a sensing value of the second sensor changing to exceed a predetermined change rate, automatically converting to the first operation mode.

Also, the control method may further include the steps of, while operating in the first operation mode, training an artificial intelligence learning model by using a first sensing value of the first sensor received through the first universal interface, diagnosing a state of a system wherein the plurality of sensors are installed based on a change pattern of the first sensing value or the second sensing value and the artificial intelligence learning model, and outputting the diagnosis result.

In addition, the step of controlling the external valve may include the steps of, based on the first sensor and the second sensor being sensors of different types, while operating in the second operation mode, assuming the first sensing value based on association data between sensing items of the first sensor and the second sensor and the sensing value of the first sensor, and controlling the external valve based on the assumed first sensing value.

### Effect of the Invention

According to the various embodiments of the disclosure as above, a breakdown state of each sensor used in a vessel fuel system and a breakdown state of the system, etc. can be swiftly and effectively diagnosed, and can be coped with. Also, the lifespan of each sensor can be extended, and the state of each sensor can be easily and simply tested.

### BRIEF DESCRIPTION OF THE DRAWINGS

FIG. 1 and FIG. 2 are block diagrams illustrating a configuration of a control device for a vessel according to various embodiments of the disclosure;

FIG. 3 is a graph illustrating an example of association data;

FIG. 4 is a diagram illustrating an example of association data;

FIG. 5 and FIG. 6 are diagrams illustrating screen display of a control device for a vessel according to an embodiment of the disclosure;

FIG. 7 and FIG. 8 are diagrams illustrating various examples of a configuration of a system wherein a control device for a vessel is installed; and

FIG. 9 to FIG. 11 are flow charts for illustrating a control method according to various embodiments of the disclosure.

### MODE FOR IMPLEMENTING THE INVENTION

Hereinafter, various examples will be described in detail with reference to the drawings. The examples described below may be implemented while being modified into several different forms.

Meanwhile, various kinds of terms and expressions used in this specification may generally be interpreted as a dictionary definition or a meaning understood by a person having ordinary skill in the pertinent field, and may be extensively interpreted in various ways.

For example, send, transmit, or transfer mentioned in this specification may mean transmission of data or information or a signal, and depending on needs, encryption/decryption may be applied.

Also, in this specification, expressions in forms such as “transmit (transfer) from A to B” or “A receives from B” include a case wherein an object is transmitted (transferred) or received while another medium is included in between, and do not necessarily express only a case wherein an object is directly transmitted (transferred) or received from A to B.

In addition, each device illustrated and mentioned in this specification may be implemented as devices independent from one another, but the disclosure is not necessarily limited thereto, and the devices may be implemented as several components included in one device.

Also, in the description of the disclosure, the order of each step should be understood in a nonrestrictive way, unless a preceding step should necessarily be performed prior to a subsequent step in a logical and temporal sense. That is, excluding an exceptional case as above, even if a process described as a subsequent step is performed prior to a process described as a preceding step, there would be no influence on the essence of the disclosure, and the scope of the disclosure should also be defined regardless of the orders of steps.

Further, the description “A or B” in this specification is defined to include not only a case wherein one of A or B is selectively referred to, but also a case wherein both of A and B are included.

In addition, the term “include” in this specification includes a case wherein elements other than elements listed as being included are further included.

Also, in this specification, only essential elements necessary for describing the disclosure are described, and elements not related to the essence of the disclosure are not mentioned. Further, the descriptions of the disclosure should not be interpreted to have an exclusive meaning of including only the elements mentioned, but to have a non-exclusive meaning of also including other elements.

In addition, mathematical operations and calculations in each step of the disclosure that will be described below may be implemented as computer operations by coding methods that are known for performing the operations or the calculations and/or coding designed to be suitable for the disclosure.

Hereinafter, the disclosure will be described in detail with reference to the accompanying drawings.

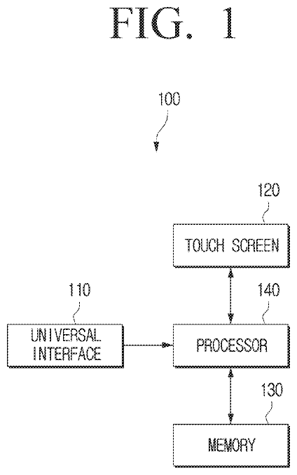

FIG. 1 is a block diagram illustrating a configuration of a control device for a vessel according to an embodiment of the disclosure. The control device for a vessel 100 in FIG. 1 may be used for a vessel fuel system. According to FIG. 1, the control device for a vessel 100 includes a universal interface 110, a touch screen 120, a memory 130, and a processor 140.

The universal interface 110 means an interface that can be selectively connected to a plurality of sensors. The universal interface 110 includes a universal port to which wired connectors connected to each sensor can be connected, and inside the universal port, at least one terminal or pin, etc. connected with the wired connectors may be included. The universal interface 110 may be implemented in various standards.

The touch screen 120 is a component for displaying various kinds of screens, and receiving input of a user signal through a touch. In this specification, explanation was described based on a case wherein the component is implemented as a touch screen, but it may be implemented as displays or manipulation panels, buttons, etc. in various forms according to the size or price, the use environment, the exterior, etc. of the control device for a vessel.

The memory 130 is a component wherein software and various kinds of data necessary for the operations of the control device for a vessel 100 are stored. The memory 130 may store association data among sensing items sensed in various types of sensors (e.g., the temperature, the viscosity, the pressure, the flow amount, the fuel level, etc.). The association data means data indicating the relation between at least two items. The manufacturer or the content provider of the control device for a vessel may experimentally measure the relation among sensing values of each sensor installed in the vessel fuel system, and then calculate association data in advance based on the measurement value. The calculated association data is stored in the memory 130. Other than the above, depending on embodiments, an artificial intelligence learning model may be stored in the memory 130.

The processor 140 is a component for controlling the overall operations of the control device for a vessel 100. The processor 140 may use a sensing value input at the universal interface 110. The processor 140 may receive input of information on the types or characteristics, etc. of the sensors connected to the universal interface 110 from the user through the touch screen 120. The processor 140 may match and use the input information and the sensing value. For example, in case a temperature sensor is connected to the universal interface 110, the user may input that it is a connection of the temperature sensor through the touch screen 120 before or after connecting the sensor. The user may input information on the characteristics of the sensor together other than the type of the connected sensor. The characteristic information may be various kinds of information such as the sensing range, the sensing unit, the name of the manufacturing company of the sensor, the name of the sensor, the serial number of the sensor, etc. If a case wherein the temperature sensor is connected is assumed, the user may input the fact that the sensor is a temperature sensor, a range between −300˜+300 degrees is the sensing range, etc.

When the information on the sensor is input, the processor 140 controls the touch screen 120 to match and display a sensing value of the sensor received through the universal interface 110 and the input information. Taking an example of the temperature sensor, the processor 140 converts an input sensing value into a corresponding temperature value within the sensing range, and then attaches an appropriate temperature unit to it and displays it through the touch screen 120.

The processor 140 may diagnose the state of a sensor connected to the universal interface 110, or the state of the environment wherein the sensor is installed based on a sensing value and the data stored in the memory 130. Specifically, if the temperature sensor installed in the fuel flow channel of the vessel fuel system is connected to the universal interface 110, the processor 140 identifies a reference value for the temperature sensor from the memory 130. The processor 140 may diagnose the state of the system wherein the temperature sensor is installed by comparing the reference value and the sensing value (e.g., an overheated state, a cooled state, etc.). Alternatively, if the sensing value has abnormal characteristics such as exceeding the reference value greatly, or drastically changing during a specific time, the processor 140 may diagnose that the temperature sensor itself is in a breakdown state.

Meanwhile, in case an artificial intelligence learning model is stored in the memory 130, the processor 140 may diagnose the state of a sensor or the state of the system wherein the sensor is installed based on the artificial intelligence learning model and a sensing value. The artificial intelligence learning model may be trained in advance by using various input values. For example, if it is assumed that the temperature sensor is connected to the universal interface 110, the processor 140 inputs a sensing value of the temperature sensor into the artificial intelligence learning model. If sensing values are input during a specific time, the artificial intelligence learning model may use the change pattern of the sensing values, and diagnose whether it is a change pattern at the time of a normal state, or a change pattern at the time of a sensor breakdown state, or a change pattern at the time of a system breakdown state. In the case of a system breakdown, the change pattern may vary according to which part broke down, and thus the processor 140 may determine the area of the breakdown and also the cause.

As the universal interface 110 is used, the user may connect one sensor and identify its sensing value, and then connect another sensor to the control device for a vessel 100 and identify its sensing value. The processor 140 may identify sensing values of various sensors that are sequentially connected, and then combine the change patterns of the sensing values and determine whether there is a breakdown in the system, the cause of the breakdown, the area of the breakdown, etc. more precisely. For example, the cause for a consistent rise of the temperature may be the breakdown of the heater, or the cause may be heightening of the viscosity of the fuel. In this case, if diagnosis is made in consideration of the values of the other sensors together, the cause can be analyzed more correctly.

Meanwhile, in FIG. 1, only one universal interface 110 was illustrated, but the number of the universal interfaces may be a plural number. In case a plurality of universal interfaces are provided, the user may respectively connect several sensors of the same type or different types to the universal interfaces, and then respectively input and set information on the sensors through the touch screen 120. Depending on embodiments, the user may respectively set a main sensor and a subsidiary sensor among several sensors. In this case, the control device for a vessel 100 may variously change the purposes of use and the use time, the use frequency, etc. of the main sensor and the subsidiary sensor. Regarding such an operation, detailed explanation will be described again in the following description.

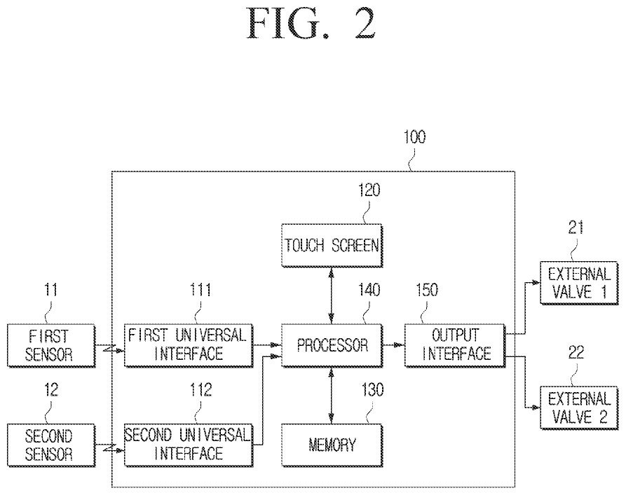

FIG. 2 illustrates a configuration of a control device for a vessel according to an embodiment including two universal interfaces. Among the components in FIG. 2, regarding the same components as those illustrated in FIG. 1, the same reference numerals will be used, and overlapping explanation will be omitted.

According to FIG. 2, the control device for a vessel 100 includes a first universal interface 111, a second universal interface 112, a touch screen 120, a memory 130, a processor 140, and an output interface 150.

The first universal interface 111 is connected with a first sensor 11, and the second universal interface 112 is connected with a second sensor 12. Here, the expressions such as the first, the second, etc. are just for distinguishing the components, and they do not mean interfaces or sensors of different types. Also, for the convenience of explanation, the sensing value of the first sensor will be referred to as a first sensing value, and the sensing value of the second sensor will be referred to as a second sensing value in this specification, but these sensing values can also obviously be values for sensing items of the same kind.

The user may respectively connect the first and second sensors 11, 12, and then input information on each sensor through the touch screen 120. The input information may be stored in the memory 130 together with the numbers of the universal interfaces.

As an example, the first sensor connected to the first universal interface 111 may automatically be recognized as the main sensor, and the second sensor connected to the second universal interface 112 may automatically be recognized as the subsidiary sensor.

As another example, the user may distinguish and set the main sensor and the subsidiary sensor by himself/herself. That is, the user may set the first sensor connected to the first universal interface 111 as the subsidiary sensor, and set the second sensor connected to the second universal interface 112 as the main sensor. Hereinafter, explanation will be described based on a case wherein the first universal interface 111 is used for the main sensor, and the second universal interface 112 is used for the subsidiary sensor.

Here, the main sensor means a sensor that can be used as a main sensor in performing one control operation, and the subsidiary sensor means a sensor that can be used as a subsidiary sensor when performing the same control operation as using the main sensor. That is, in the case of performing a temperature control operation based on the viscosity sensor, if temperature-viscosity association data exists, the temperature sensor may perform the role of the subsidiary sensor.

The output interface 150 is a component for transmitting a signal output from the control device for a vessel 100 to external means. The output interface 150 may be connected with external valves 1, 2 (21, 22), etc. The processor 140 may output control signals in various forms such as a voltage control signal, a current control signal, a pressure control signal, etc. through the output interface 150 according to the types of the external valves 1, 2 (21, 22). The types of the external valves to be controlled and the characteristics of control signals for them may be set in advance to match the type of the sensor, or they may be implemented in a form of being directly input by the user through the touch screen 120. In FIG. 2, one output interface 150 was illustrated, but the number may change variously.

The processor 140 may operate in various operation modes in a state wherein the first and second sensors 11, 12 are respectively connected to the first and second universal interfaces 111, 112. As examples of the operation modes, there may be a first operation mode of using the main sensor, a second operation mode of using the subsidiary sensor, an AI mode of alternately using the main sensor and the subsidiary sensor according to a predetermined condition, etc. The number of the operation modes may be added or reduced according to the use environment, and the specification, the use, etc. of the control device for a vessel, and the types of the operation modes may also be changed. Also, whether a sensor will be used or not may be controlled by a method of introducing fuel into the flow channel wherein the sensor is arranged or blocking the introduced fuel. That is, in the case of the viscosity sensor or the temperature sensor, etc., there are parts that directly contact fuel, and thus the lifespan can be shortened if the sensor is constantly exposed to the flow of fuel. Accordingly, for extending the lifespan, a fuel inlet valve for a flow channel wherein a sensor that is not used is arranged may be blocked. As an example, in the AI mode, the processor 140 alternately opens or closes a first fuel inlet valve for the first flow channel wherein the main sensor is arranged, and a second fuel inlet valve for the second flow channel wherein the subsidiary sensor is arranged, and thereby enables the main sensor and the subsidiary sensor to be used alternately.

Like in the AI mode, if the control device for a vessel 100 alternately uses the first and second sensors, the lifespan of each sensor can be extended. Also, in case the main sensor from among the two sensors broke down, the user may select the second operation mode and use the subsidiary sensor, and may thereby cope with the breakdown swiftly.

Conditions for changing the sensor used in the AI mode may be designed variously according to embodiments. As an example, in case the vessel fuel is being used stably without a special circumstance, and the system is also being operated stably, the subsidiary sensor may be used, and in case they are unstable, the main sensor may be used. Specifically, while the processor 140 operates in the first operation mode, if the sensing value of the main sensor is maintained within a specific numerical range during a predetermined time, the processor 140 automatically converts to the second operation mode. Afterwards, if the sensing value of the subsidiary sensor changes to exceed a predetermined standard change rate, or is detected as a value that is excessively big or excessively small, the processor 140 automatically converts to the first operation mode.

As another example, the processor 140 may alternately change and use the main sensor and the subsidiary sensor per designated time unit.

As still another example, in a training section wherein the artificial intelligence learning model is trained, or in a situation wherein precise sensing is required, the processor 140 may operate in the first operation mode of using the main sensor, and if training is completed or in a situation wherein precise sensing is not required, the processor 140 may automatically convert to the second operation mode of using the subsidiary sensor.

As still another example, if a breakdown of the main sensor is detected, the processor 140 may automatically convert to the second operation mode of using the subsidiary sensor. In this case, the processor 140 may notify to the user that the main sensor broke down through the touch screen 120 or other output means.

Meanwhile, the first sensor and the second sensor may be of the same type, but they may be sensors of different types. For example, the user may connect the viscosity sensor as the main sensor, and connect the temperature sensor as the subsidiary sensor.

In this case, the processor 140 may perform each operation mode based on the association data stored in the memory 130. Specifically, if the first and second sensors 11, 12 are respectively connected to the first and second universal interfaces 111, 112 and information on each sensor is input through the touch screen 120, the processor 140 identifies the association data among the sensing items respectively sensed by the first and second sensors 11, 12 from the memory 130.

The processor 140 controls the external valve by using the first sensing value of the first sensor 11 as it is in the first operation mode, and assumes the first sensing value by using the sensing value of the second sensor 12 and the association data in the second operation mode. The processor 140 controls the external valve by using the assumed first sensing value. If the association data is used as above, even if the plurality of sensors are of different types, the sensors can be used together and control the same subject for control. Accordingly, the lifespan of each sensor can be extended.

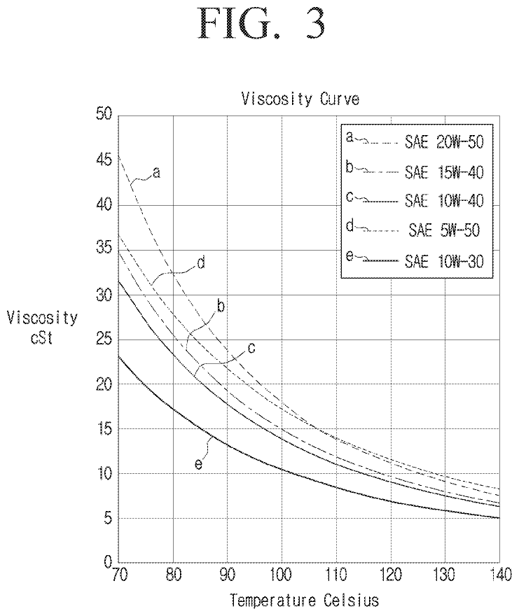

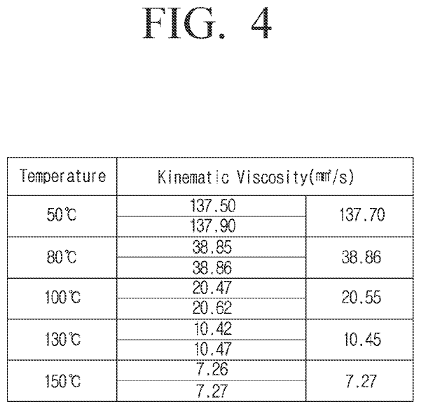

FIG. 3 and FIG. 4 are diagrams for illustrating association data between the temperature and the viscosity. First, FIG. 3 illustrates an example of association data in a graph form indicating the relation between the temperature and the viscosity. In FIG. 3, the horizontal axis indicates the temperature, and the vertical axis indicates the viscosity. Each graph in FIG. 3 indicates the characteristics of the relation between the temperatures and the viscosity that are had by a plurality of oil types having different viscosity numerical values designated by the Society of Automotive Engineers (SAE). Like this, each fuel has different numerical values, but has a characteristic that its viscosity is lowered as the temperature rises.

FIG. 4 illustrates an example of association data between the temperature and the viscosity of one fuel among them. According to FIG. 4, it can be figured out that the fuel is a fuel having kinematic viscosity of 137. 70 at 50 degrees. The kinematic viscosity means a value of dividing the viscosity by the density of the fluid. As density is not a changing value, expressing the relation as the relation between the temperature and the viscosity may not limit the relation only to the relation between the viscosity itself and the temperature, but the relation may also be interpreted as the relation between the temperature and the kinematic viscosity. Accordingly, in this specification, explanation will be described by generally referring to the relation as the relation between the temperature and the viscosity without distinction.

The association data as in FIG. 3 and FIG. 4 may be secured in advance at the manufacturing company of the control device for a vessel 100, and then stored in the memory 130. The processor 140 may assume the viscosity of the fuel that is currently being used at the current temperature based on the association data stored in the memory 130. The viscosity assumed here may be the viscosity itself, or it may be the kinematic viscosity. For example, if the association graph (a) for an oil of the SAE 20W-50 grade is deemed as a standard, in case the temperature is 130 degrees, the kinematic viscosity may be assumed as about 10 cSt. The control device for a vessel 100 may store in advance the association data (a-e) for oils of various grades, and use the association data corresponding to the type of the vessel oil currently used in the vessel fuel system.

The manufacturing company of the control device for a vessel 100 may secure the association data between the temperature and the viscosity based on the reference kinematic viscosity information provided from a fuel analysis report, and an ASTM D341 equation, etc. Alternatively, the manufacturing company may secure the association data between the temperature and the viscosity by an experimental method of adjusting temperature conditions differently for each fuel and directly measuring and recording viscosity corresponding thereto. In this case, the processor 140 may consistently update the association data between the temperature and the viscosity based on data that is secured in a process of using the control device 100 for a vessel in an actual environment after it is applied to a system.

Alternatively, in case a component such as a communicator (not shown) is added to the control device for a vessel 100, the processor 140 may transmit the temperature information and the viscosity information measured by the first sensor and the second sensor to an external device through the communicator. The external device may update the association data between the temperature and the viscosity based on the information collected from a plurality of control devices for a vessel respectively applied to a plurality of vessels, and transmit the data again. The processor 140 may update the transmitted data in the memory 130, and improve the precision of assuming the viscosity.

Other than the temperature and the viscosity, association exists between each sensing item, and thus association data can be secured through repetitive experiments. For example, if a flow amount sensed at the flow amount sensor increases, the fuel level sensed at the level sensor may also increase. Also, if the pressure sensed at the pressure sensor increases, the flow rate sensed at the flow rate sensor may also increase. In addition, if the viscosity increases, the flow rate may decrease.

Meanwhile, in case only one universal interface is provided as in FIG. 1, the user may sequentially connect the plurality of sensors to the universal interface. If at least two sensors among the plurality of sensors are sequentially connected to the universal interface 110, the processor 140 identifies the association data between the sensors from the memory 130. The processor 140 puts the sensing value of the first sensor connected first into the association data, and assumes the sensing value of the second sensor connected later. Afterwards, when the second sensor is connected and the sensing value of the second sensor is actually acquired, the processor 140 compares the sensing value with the assumed sensing value. If the difference is within a specific error range as a result of comparison, the processor 140 regards the second sensor as normal. In contrast, if there is a difference exceeding the error range, the processor 140 may recognize that at least one of the first sensor or the second sensor is in a breakdown state, and output the recognition result through the touch screen 120 or other output means.

Meanwhile, in the memory 130, not only association data among the sensing items of each of the plurality of sensors, but also information on a plurality of coping solutions corresponding to sensor breakdown and system breakdown states may be stored.

Based on a sensing value of a sensor connected to the universal interface 110 among the plurality of sensors, the processor 140 diagnoses whether there is a breakdown in the connected sensor or the system area wherein the sensor is installed. If it is determined, as a result of diagnosis, that there is a breakdown, the processor 140 identifies coping solution information corresponding to the area of the breakdown from the memory 130, and then performs a control operation based on it. Such a diagnosis of a breakdown can be performed more precisely and swiftly if the aforementioned artificial intelligence learning model is used.

If it is determined that the connected sensor itself broke down, the processor 140 displays the types of sensors that can replace the sensor on the touch screen. A sensor that can replace the sensor means a sensor which is in a relation that the association data is stored. For example, if temperature-viscosity association data is stored, the temperature sensor may be displayed as a replacement sensor when it is determined that the viscosity sensor broke down. Accordingly, if the replacement is connected to the universal interface, the processor 140 assumes the sensing value of the sensor that broke down from the sensing value of the replacement sensor based on the association data. The processor 140 displays the assumed value on the touch screen 120.

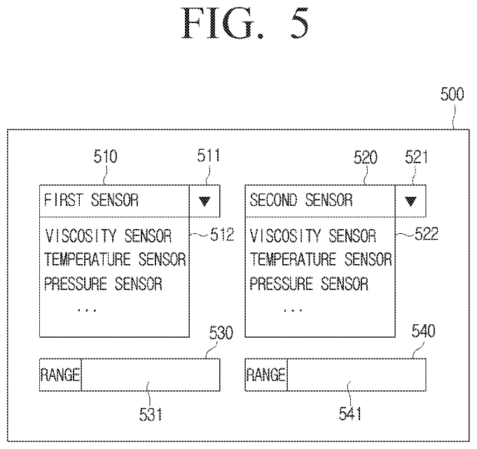

FIG. 5 illustrates an example of screen display of a control device for a vessel according to an embodiment of the disclosure. According to FIG. 5, if any sensor is connected to the universal interface 110, the control device for a vessel 100 displays a UI screen 500 for inputting the information of the sensor.

On the UI screen 500, sensor selection areas 510, 520 and information input areas 530, 540 for each of the universal interfaces 111, 112 are displayed. If selection buttons 511, 521 of the selection areas 510, 520 for the first sensor or the second sensor are touched, the processor 140 displays the types of the sensors that can be selected in lists 521, 522. When the user selects a sensor in each list 521, 522, and selects a sensing range in the information input areas 531, 541 in the lower part, the processor 140 matches the input information and the type of the sensor with each of the sensors connected to the first or second universal interface 111, 112 and stores them.

In FIG. 5, only the areas 530, 540 wherein the sensing ranges are input were illustrated, but areas wherein various kinds of related information such as the manufacturing company of the sensor, the product name, the product serial number, etc. other than the sensing range are input may be added. Also, in FIG. 5, the UI screen 500 was illustrated in a form wherein the user directly inputs the sensing range, but the UI screen 500 may be constituted in a form wherein sensing ranges that can be measured are displayed in a list, and the user selects a sensing range.

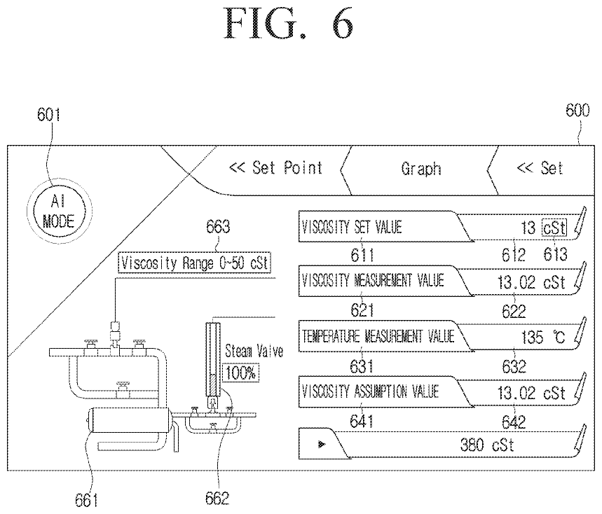

FIG. 6 illustrates another example of screen display of a control device for a vessel. According to FIG. 6, on the UI screen 600, a first area 611 indicating a set value for the first sensing item, a second area 621 indicating a sensing value of the first sensor, a third area 631 indicating a sensing value of the second sensor, and a fourth area 641 indicating an assumed first sensing value based on the second sensing value, and a button 601 for mode conversion, an image 661 indicating the configuration of the fuel system, an object 662 indicating the fuel adjustment state, and a viscosity measurement range 663, etc. are displayed.

After types of sensors and related information, etc. are input through the UI screen in FIG. 5, the processor 140 may constitute the UI screen 600 in a form as in FIG. 6 based on the input information and the sensing value, and display the UI screen 600. In this case, in the first to fourth areas 611-641, texts related to the type of the connected sensor, e.g., a viscosity set value, a viscosity measurement value, a temperature measurement value, a viscosity assumption value, etc. may be displayed.

Alternatively, the processor 140 may receive input of the types of sensors and the related information, etc. on the UI screen 600 in FIG. 6 itself. In the first area 611, an area 612 for receiving input of a target value, and a selection area 613 wherein a set unit can be selected are displayed together. For example, if the selection area 613 is selected and viscosity is input, cSt which is the viscosity unit is automatically displayed.

Specifically, if the areas 621, 631 indicating the types of the sensing items are selected in the UI screen 600, lists wherein the sensing items can be selected may respectively be displayed. If the viscosity sensor and the temperature sensor are respectively selected in the second area 621 and the third area 631, the first sensing value and the second sensing value are respectively displayed in the display areas 622, 632. Also, the fourth area 641 may be displayed in the form of a touch button that can select association data. If temperature-viscosity data is selected in the fourth area 641, the processor 140 assumes the viscosity based on the association data, and displays it in the display area 642 of the fourth area 641.

As in FIG. 6, if the viscosity set value is set through the first area 611, the processor 140 may perform a control job of heating or cooling the vessel oil such that the viscosity corresponding to the viscosity set value is maintained.

The colors or the display states of the image 661 indicating the configuration of the fuel system and the object 662 indicating the fuel adjustment state may vary according to the control state for the vessel oil. Specifically, while raising the temperature for lowering the viscosity of the vessel oil, the processor 140 controls the touch screen 120 to display the color of the object 662 in the first color (e.g., the red color). In contrast, while lowering the temperature for heightening the viscosity, the processor 140 controls the touch screen 120 to display the color of the object 662 in the second color (e.g., the blue color). The length of the object 662 may vary according to the adjustment state of the control valve. For example, in case the control valve is opened to 100%, the length of the object displayed in a color may be displayed to be the longest as possible, and in case the control valve is opened only to 50%, the length may be displayed as the half.

Also, the shape or the color of the image 561 indicating the configuration of the fuel system can also be changed. For example, in case the moving path of the vessel oil is changed by locking or opening the valves of some lines among the entire pipelines, the processor 140 may display the color of the pipeline image corresponding to the path wherein the vessel oil moves, and the color of the pipeline image corresponding to a path wherein the vessel oil does not move differently.

The button 601 is a component for selection and change of the operation mode. According to an embodiment, it may be designed such that, when the button 601 is selected, the processor 140 shows a list of the entire operation modes, and immediately converts to an operation mode selected in the list.

As another example, whenever the button 601 for mode conversion is selected, the processor 140 may change the operation mode in a toggle form.

In the case of operating by a toggle method, the processor 140 sequentially changes a plurality of operation modes whenever the button 601 is touched, and displays the current operation mode on the button 601.

The operation modes may be implemented in various types and numbers. As an example, the processor 140 may operate in one mode among a first operation mode of using the first sensor, a second operation mode of using the second sensor, or an AI mode of alternately using the first and second sensors according to a predetermined condition.

The predetermined condition may vary depending on embodiments. As an example, if it is set that the operation mode is changed by a specific time unit, in the AI mode, the processor 140 may alternately perform the first operation mode and the second operation mode per designated time.

As another example, in the AI mode, the processor 140 operates in the first operation mode as a default, and then if it enters a stable section wherein the sensing value is maintained within a specific numeral range during a predetermined time, the processor 140 automatically converts to the second operation mode. While operating in the second operation mode, if it is determined that it is a drastic change section wherein the sensing value of the second sensor changes to exceed a predetermined change rage, the processor 140 automatically converts to the first operation mode.

As still another example, the processor 140 operates in the first operation mode during a training section wherein the artificial intelligence learning model stored in the memory 130 is trained, and automatically converts to the second operation mode when the training section is completed.

The examples of the AI mode may vary according to whether the first sensor and the second sensor are of the same type, or of different types. For example, in case the sensors are different sensors, the value of the first sensor should be assumed by using the second sensor, but in case the sensors are sensors of the same type, the second sensing value may be used as the first sensing value as it is without an assuming job. Accordingly, in the case of the sensors of the same type, the operation time of the second operation mode may be set to be longer than the case of the sensors of different types. Alternatively, the condition for the drastic change of converting into the second operation mode may be set in a more mitigated way.

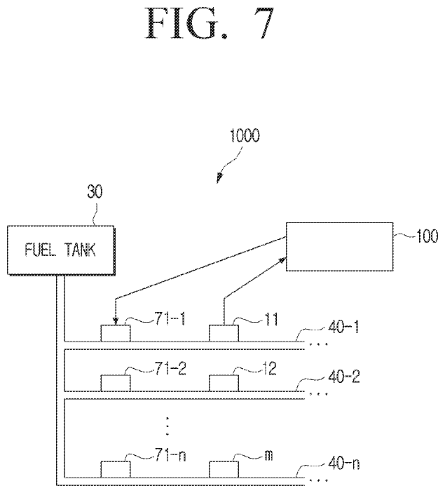

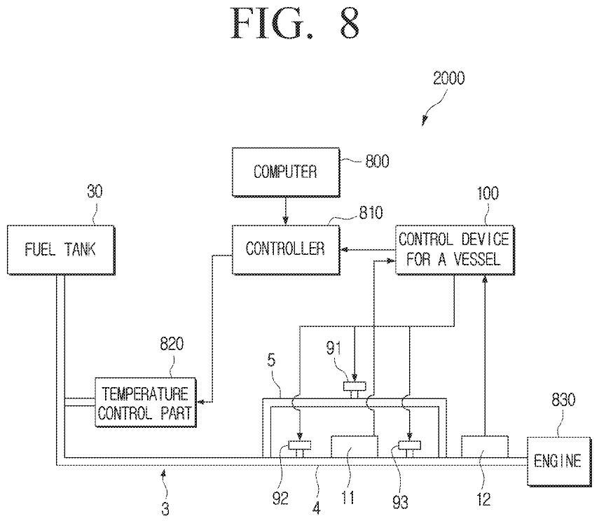

FIG. 7 and FIG. 8 are diagrams illustrating a configuration of a vessel fuel system to which the control device for a vessel 100 is applied.

According to FIG. 7, the vessel fuel system 1000 consists of a plurality of flow channels 40-1-40-n connected to the fuel tank 30, and in each flow channel 40-1-40-n, fuel inlet valves 71-1-71-n are arranged. Also, in each flow channel 40-1-40-n, at least one sensor 11, 12—m may be arranged. As the configuration of the flow channels, the arrangement locations of the sensors and the valves in FIG. 7 expressed the configuration of an actual vessel fuel system simply for explaining the operations in this embodiment, it is obvious that the detailed configuration of an actual system can be constituted to be more complex than this.

The control device 100 for a vessel includes an output interface (not shown) that can be connected to at least one among each fuel control valve. The control device 100 for a vessel can control use or nonuse of a sensor by a method of introducing fuel into the flow channel wherein the sensor is arranged or blocking introduction. For example, in case the first sensor 11 is to be used, the processor 140 may control the first fuel inlet valve 71-1 for the first flow channel 40-1 wherein the first sensor 11 is arranged, and make fuel pass through the first flow channel 40-1. In contrast, in case the second sensor 12 is to be used without using the first sensor 11, the processor 140 may control the first fuel inlet valve 71-1 and block introduction of fuel into the first flow channel 40-1, and control the second fuel inlet valve 71-2 and make fuel introduced into the second flow channel 40-2 wherein the second sensor 12 is arranged.

FIG. 8 illustrates another configuration example of a vessel fuel system. The vessel fuel system 2000 in FIG. 8 illustrates a case wherein a flow channel 3 between the fuel tank 30 and the engine 830 is branched into a flow channel 4 wherein the first sensor 11 is arranged and a flow channel 5 that bypasses the first sensor 11, and fuel control valves 91, 92, 93 are arranged in the two flow channels 4, 5.

Also, on one side of the flow channel 4, a temperature control part 820 is arranged, and a controller 810 controlling the operations of the entire vessel fuel system 2000, and a computer 800 for controlling the entire system may be further included.

The temperature control part 820 is a component for controlling the temperature by heating or cooling the temperature of the vessel oil. The temperature control part 820 may be implemented as various components such as a heater, a cooling water tank, a thermoelectric module, etc. As detailed components for controlling the temperature of the fuel were already known in documents that were published, detailed illustration and explanation will be omitted.

The controller 810 is a component for controlling the overall operations of the vessel fuel system 2000. The controller 810 is connected with the computer 800, etc., and receives various kinds of control signals, and activates the components of the entire system according to the control signals, and controls the operations of each component.

In an embodiment, the controller 810 may be connected with the control device for a vessel 100, and control the temperature control part 820 according to a sensor signal or a control signal provided from the control device for a vessel 100. That is, as described above, the control device for a vessel 100 can be connected with various kinds of sensors, and thus it may be utilized by various methods.

As the first method, the control device for a vessel 100 may be used as an option for replacing a sensor that broke down. That is, in case one sensor broke down, the user may connect the control device for a vessel 100 to another sensor. In this case, the processor 140 matches the connected sensor and information input by the user, and recognizes the sensing item. If the item of the set value, i.e., the target value is different from the sensing item, the processor 140 assumes the sensing value of the item corresponding to the set value by using the association data.

As an example, in case the viscosity sensor broke down, the user may connect the temperature sensor to the control device for a vessel 100. The processor 140 assumes a viscosity value from the temperature value based on the temperature-viscosity association data. The processor 140 may compare the assumed viscosity value with the set value and transmit a heating signal or a cooling signal to the controller 810, and the controller 810 may control the temperature control part 820 based on this. In another example, the control device for a vessel 100 may transmit only an assumed sensing value to the controller 810, and the controller 810 may compare it with the set value and determine whether to heat or cool. As still another example, if the control device for a vessel 100 is directly connected to the temperature control part 820 and other external components, it may directly control the state of the vessel oil. Accordingly, even in case the controller 810 broke down, immediate coping becomes possible.

In such an embodiment, reference information for each sensor may be stored in the memory 130. The processor 140 may compare the reference information of the memory 130 and a sensing value received through the universal interface 110, and determine whether the sensor broke down.

Alternatively, in the memory 130, along with association data among the sensing items of each of the plurality of sensors, information on a replacement sensor that can replace each sensor by using the association data may be stored. If it is determined that one sensor broke down, the processor 140 may determine other sensors wherein association data exists between the sensor that broke down as replacement sensors, and notify information on the replacement sensors to the user through the touch screen 120 or other output means.

Alternatively, in the memory 130, not only association data but also information on a plurality of coping solutions corresponding to sensor breakdown and system breakdown states may be stored. The processor 140 diagnoses whether there is a breakdown in a sensor or a system area wherein the sensor is installed, and if it is determined that there is a breakdown, performs a control operation based on coping solution information corresponding to the area of the breakdown. A coping solution means a method that can cope with a cause of a breakdown, and coping solution information means various kinds of information necessary for implementing the coping solution. In the case of a sensor breakdown, information on a replacement sensor that can replace the sensor that broke down, a guide message guiding to replace the sensor with the replacement sensor, and control information controlling to output such a guide message and replacement sensor information, etc. may be the coping solution information. Other than the above, in the case of diagnosing a breakage or a leakage of a specific flow channel area, a guide message for notifying the area, and information on a manager who can repair the area, etc. may be the coping solution information.

As the second method, the user may use the control device for a vessel 100 for the use for extending the lifespan of the sensors in the existing system. Specifically, the user may connect the plurality of sensors to the control device for a vessel 100 as described above, and then execute the AI mode and alternately use each sensor. The user may use the sensors installed in the existing system as they are, or arbitrarily add a subsidiary sensor. For example, in the case of a state wherein one first sensor 11 is implemented as a viscosity sensor and arranged in a system as in FIG. 8, the user may add the second sensor 12 on the flow channel, and then connect the second sensor 12 to the second universal interface 112 of the control device for a vessel 100 and register it as a subsidiary sensor.

In such a state, the control device for a vessel 100 may control the operations of the fuel control valves 92, 93 arranged around the first sensor 11, and another fuel control valve 91 arranged in another flow channel 5, and change the operation mode. For example, if the fuel control valves 92, 93 of the basic flow channel 4 are opened, the fuel gets to sequentially pass through the first sensor 11 and the second sensor 12. The control device for a vessel 100 may basically perform control based on the sensing value of the first sensor 11, and assume the first sensing value by subsidiarily utilizing the sensing value of the second sensor 12. By comparing the assumed sensing value and the first sensing value, the control device for a vessel 100 can immediately determine whether there is a breakdown in the first sensor 11.

In contrast, if the fuel control valves 92, 93 of the basic flow channel 4 are closed, and the fuel control valve 91 of the subsidiary flow channel 5 is opened, the fuel does not pass through the part wherein the first sensor 11 is arranged, but gets to pass through only the location wherein the second sensor 12 is arranged. Accordingly, the time that the first sensor 11 contacts the fuel and is physically influenced can be reduced, and thus the lifespan can be extended. If the second sensor 12 is arranged on the same flow channel as the first sensor 11 as in FIG. 8, the second sensor 12 gets to be always used regardless of the operation mode. However, if a sensor of a simple configuration that is relatively cheap or has good durability compared to the first sensor 11 is used as the second sensor 12, its lifespan may not matter so much.

As the third method, the control device for a vessel 100 may comprehensively determine whether there is a breakdown in the entire system, the area of the breakdown, the cause of the breakdown, whether there is a breakdown in a sensor, etc. based on the artificial intelligence learning model. That is, if the user connects a plurality of sensors to the control device for a vessel 100, the control device for a vessel 100 may train the artificial intelligence learning model by using a change pattern of sensing values in a normal state as an input value. The artificial intelligence learning model may be trained in advance by using result values sensed in various environments before the release of the control device for a vessel 100, or may be trained by receiving input of a change pattern in a navigation process of a vessel to which the vessel fuel system 2000 is applied in real time or periodically. If the number of the universal interfaces is insufficient compared to the entire sensors, the user may frequently change the types of the sensors and connect the sensors to the control device for a vessel 100. Accordingly, the control device for a vessel 100 identifies the relation among sensing values of each sensor, and if a characteristic change is sensed, detects information on causes that may cause the change and the part wherein the change occurred, etc. through the artificial intelligence learning model. The control device for a vessel 100 may display the detected information through the touch screen 120, or transmit the information to an external terminal device through the communicator (not shown). For example, in case fuel is leaked from a specific flow channel, the sensing value of the pressure sensor and the fuel level sensed at the level sensor, etc. around it may change together. In contrast, in case sediment is generated in a specific part, the fuel level, etc. may not change, but the ambient pressure value or flow rate, etc. may change. As described above, by using a change pattern of sensing values of various sensors, the control device for a vessel 100 can easily and swiftly identify not only whether there is a breakdown in a sensor or the system, but also the cause or the part of the breakdown.

Other than the above, in case a specific sensor broke down, different types of sensors may be attached, and connected to the control device for a vessel 100, and the sensing value of the item that was sensed by the sensor that broke down may be assumed through the different types of sensors and used. In case a specific sensor broke down during a navigation of the vessel and there is no stock for the sensor, in a conventional situation, there was a risk of having to keep navigating without the sensor until the next destination, but if the control device for a vessel 100 according to the disclosure is used, the situation can be coped with swiftly by using different types of sensors.

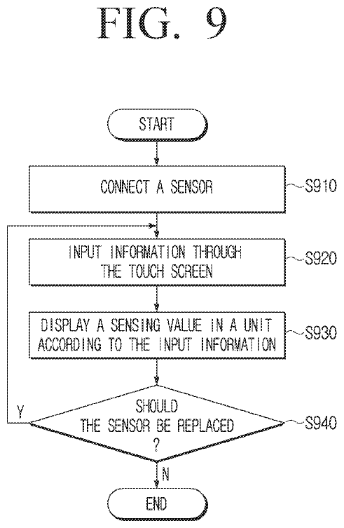

FIG. 9 is a flow chart for illustrating a control method of a control device for a vessel according to an embodiment of the disclosure.

According to FIG. 9, if the user connects a sensor in operation S910, and inputs information related to the sensor through the touch screen in operation S920, the control device for a vessel 100 displays a sensing value received from the sensor through a universal interface in a unit according to the input information in operation S930. Afterwards, when the sensor is replaced in operation S940, the control device for a vessel 100 newly receives input of information on the replaced sensor, and matches and displays the input information and a new sensing value. Like this, if a control device for a vessel including at least one universal interface is used, values of various types of sensors can be identified in one control device for a vessel. In FIG. 9, operations only to the operation of displaying information were described, but the control device for a vessel may control a subject for control based on the identified information. The subject for control may vary according to the types of sensors. For example, in the case of a viscosity sensor or a temperature sensor, the subject for control may be the heater or the cooling device, etc. of the vessel fuel system. In contrast, in the case of a flow amount sensor or a flow rate sensor, a level sensor, etc., the engine or various types of control valves, the touch screen, etc. of the vessel fuel system may be the subjects for control. That is, in case the flow amount or the level became noticeably lower, the processor of the control device for a vessel may control the touch screen to output a notification message.

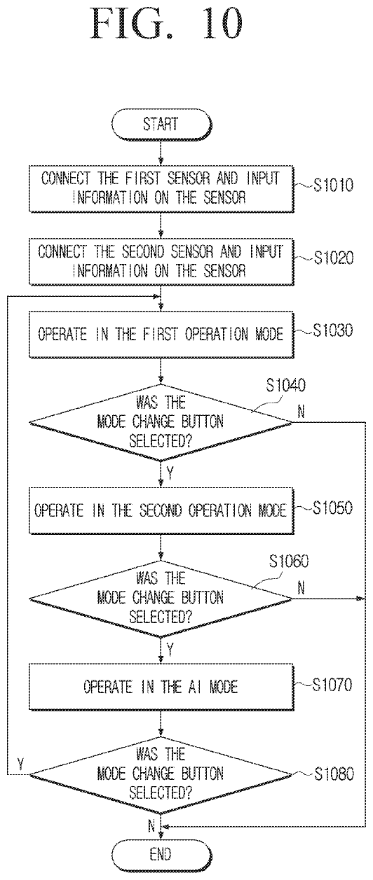

FIG. 10 is a flow chart for illustrating a control method according to another embodiment of the disclosure. According to FIG. 10, if the first sensor is connected to the control device for a vessel and then information on the sensor is input in operation S1010, and the second sensor is also connected and information on the sensor is input in operation S1020, the control device for a vessel may perform various kinds of control operations by using at least one of the first sensor or the second sensor according to the operation mode.

If the operation mode is set as the first operation mode of using the first sensor as a default, the control device for a vessel first operates in the first operation mode in operation S1030. If the mode change button is selected in such a state in operation S1040, the control device for a vessel changes to the second operation mode of using the second sensor in operation S1050. If the mode change button is selected again in operation S1060, the control device for a vessel changes to the AI mode in operation S1070. If the mode change button is selected again in operation S1080, the control device for a vessel operates in the first operation mode again in operation S1030. Like this, a plurality of operation modes may be selectively performed through one button manipulation. In the AI mode, the first operation mode and the second operation mode are alternately performed. As detailed explanation in this regard was described in the aforementioned parts, overlapping explanation will be omitted.

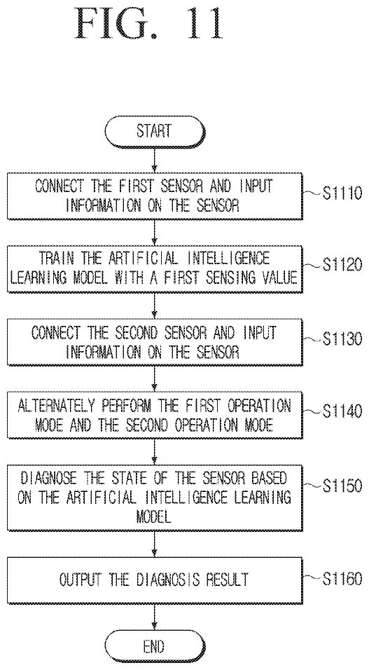

FIG. 11 is a flow chart for illustrating a control method according to still another embodiment of the disclosure. According to FIG. 11, if the first sensor is connected and information on the sensor is input in operation S1110, the artificial intelligence learning model is trained with a first sensing value sensed at the first sensor in operation S1120.

If the second sensor is also connected and information on the sensor is input in operation S1130, the control device for a vessel alternately performs the first operation mode and the second operation mode in operation S1140. As detailed explanation regarding the operations in each operation mode and the conditions for conversion of the operation modes was described in the aforementioned other embodiments, overlapping explanation will be omitted.

The control device for a vessel inputs a change pattern of the sensing values input at the first and second sensors into the artificial intelligence learning model, and diagnoses the state of each sensor in operation S1150. In this case, the control device for a vessel may diagnose not only the state of the sensor but also the state of the system wherein the sensor is attached together.

The control device for a vessel may provide the diagnosis result to the user by various methods through a display means provided in itself or a speaker means or the communicator, etc. in operation S1160. If the diagnosis result is a normal state, the control device for a vessel does not necessarily have to provide the result, but in case it is determined that there is a breakdown in a specific part or a sensor as a result of diagnosis, the control device for a vessel may output the diagnosis result and immediately notify it to the user.

In the above, various embodiments were explained by using flow charts and block diagrams. However, the orders of the steps illustrated in each flow chart are merely examples, and the orders may be changed according to situations. In particular, in FIG. 10 and FIG. 11, it was illustrated and explained that the first sensor is connected first and the second sensor is connected later, but the connection order is not restrictive. Also, depending on embodiments, some steps may be omitted, or steps may be added.

If the vessel oil is managed as in the aforementioned embodiments, not only the lifespan of a sensor can be extended, but it is also possible to cope with immediately even if some parts of a sensor or the system break down. Also, the cause of the breakdown can be identified swiftly, and can be notified to the user.

The control method according to the aforementioned various embodiments may be stored in a recording medium in the form of a program code for performing the method and distributed. Specifically, a program code that performs the collecting method according to the aforementioned various embodiments when executed by an electronic device may be distributed while being stored in a recording medium, or distributed online.

Here, the program code may be a code for sequentially executing the step of, if a first sensor which is one of a plurality of sensors is connected to a first universal interface and information on the first sensor is input through the touch screen, matching and displaying a first sensing value received through the first universal interface and the input information, and the step of, if a second sensor which is one of the plurality of sensors is connected to a second universal interface and information on the second sensor is input through the touch screen, matching and storing a second sensing value received through the second universal interface and the information input regarding the second sensor, and the step of alternately opening or closing a first fuel inlet valve for a first flow channel wherein the first sensor is arranged and a second fuel inlet valve for a second flow channel wherein the second sensor is arranged, and alternately using the first sensor and the second sensor, etc. Other than the above, some steps may be changed or deleted, or an added code may be used so as to match the aforementioned various embodiments.

A device on which a recording medium storing such a program code is loaded can perform the operations according to the aforementioned various embodiments.

A recording medium may be various types of computer-readable mediums such as a ROM, a RAM, a memory chip, a memory card, an external hard, a hard, a CD, a DVD, a magnetic disk, or a magnetic tape, etc.

So far, the disclosure has been described with reference to the accompanying drawings, but the scope of the disclosure is intended to be determined by the appended claims, and is not intended to be interpreted as being limited to the aforementioned embodiments and/or drawings. Also, it should be clearly understood that alterations, modifications, and amendments of the disclosure described in the claims that are obvious to a person having ordinary knowledge in the art are also included in the scope of the disclosure.

What is claimed is:

1. A control device for a vessel comprising:
a universal interface that can be selectively connected to a plurality of sensors;
a touch screen;
a memory; and
a processor,
wherein the processor is configured to:
based on one of the plurality of sensors being connected to the universal interface and information on the connected sensor being input through the touch screen, control the touch screen to match and display a sensing value received through the universal interface and the input information, and
diagnose a state of a system wherein the plurality of sensors are installed based on an artificial intelligence learning model stored in the memory and the sensing value.

2. The control device for a vessel of claim 1,
wherein the universal interface comprises:
a first universal interface and a second universal interface, and
the processor is configured to:
based on a main sensor being connected to the first universal interface and a subsidiary sensor being connected to the second universal interface, alternately open or close a first fuel inlet valve for a first flow channel wherein the main sensor is arranged and a second fuel inlet valve for a second flow channel wherein the subsidiary sensor is arranged, and alternately use the main sensor and the subsidiary sensor.

3. The control device for a vessel of claim 1,
wherein the universal interface comprises a first universal interface and a second universal interface, and
the processor is configured to:
in a state wherein a main sensor is connected to the first universal interface and a subsidiary sensor is connected to the second universal interface, according to the number of times of touches of a menu on the touch screen, operate in one mode among a first operation mode of using the main sensor, a second operation mode of using the subsidiary sensor, or an AI mode of alternately using the main sensor and the subsidiary sensor according to a predetermined condition.

4. The control device for a vessel of claim 2,
wherein the processor is configured to:
while operating in a first operation mode of using the main sensor, based on a sensing value of the main sensor being maintained within a specific numerical range during a predetermined time, automatically convert to a second operation mode of using the subsidiary sensor, and
while operating in the second operation mode, based on a sensing value of the subsidiary sensor changing to exceed a predetermined change rate, automatically convert to the first operation mode.

5. The control device for a vessel of claim 2,
wherein the processor is configured to:
operate in a first operation mode of using the main sensor during a training section of training the artificial intelligence learning model, and based on the training section being completed, automatically convert to a second operation mode of using the subsidiary sensor.

6. The control device for a vessel of claim 1,
wherein the memory stores association data among sensing items of each of the plurality of sensors,
the universal interface comprises a first universal interface and a second universal interface, and
the processor is configured to:
based on information on a first sensor connected to the first universal interface and a second sensor connected to the second universal interface being respectively input through the touch screen, identify the association data between the sensing item of the first sensor and the sensing item of the second sensor from the memory, and
alternately perform a first operation mode of controlling an external valve based on a first sensing value input from the first sensor and a second operation mode of assuming the first sensing value from a second sensing value input from the second sensor and the identified association data and controlling the external valve based on the assumed first sensing value.

7. The control device for a vessel of claim 6,
wherein the processor is configured to:
based on a change rate of the second sensing value exceeding a predetermined standard change rate while performing the second operation mode, automatically convert to the first operation mode.

8. The control device for a vessel of claim 1,
wherein the memory stores association data among sensing items of each of the plurality of sensors, and
the processor is configured to:
based on at least two sensors among the plurality of sensors being sequentially connected to the universal interface, identify association data on sensor items of each sensor from the memory, and diagnose whether there is a breakdown in each of the at least two sensors based on the association data.

9. The control device for a vessel of claim 1, further comprising:
an output interface that can be connected to a plurality of external valves,
wherein the processor is configured to:
output an output signal in a form corresponding to the type of the sensor connected to the universal interface through the output interface, and
the output signal is one of a voltage control signal, a current control signal, or a pressure control signal.

10. The control device for a vessel of claim 1,
wherein the memory stores association data among sensing items of each of the plurality of sensors and information on a plurality of coping solutions corresponding to sensor breakdown and system breakdown states, and
the processor is configured to:
based on a sensor value of a sensor connected to the universal interface among the plurality of sensors, diagnose whether there is a breakdown in the connected sensor or a system area wherein the sensor is installed, and based on determining that there is a breakdown, perform a control operation based on coping solution information corresponding to the area of the breakdown.

11. The control device for a vessel of claim 10,
wherein the processor is configured to:
based on determining that there is a breakdown in the connected sensor, display the types of sensors that can replace the connected sensor on the touch screen, and
based on a replacement sensor being connected to the universal interface, assume a sensor value of the sensor that broke down from a sensor value of the replacement sensor based on the association data stored in the memory, and display the sensor value on the touch screen.

12. A control method of a control device for a vessel comprising a plurality of universal interfaces that can be selectively connected to a plurality of sensors, the method comprising:
based on a first sensor which is one of the plurality of sensors being connected to a first universal interface and information on the first sensor being input through a touch screen, matching and displaying a first sensing value received through the first universal interface and the input information;
based on a second sensor which is one of the plurality of sensors being connected to a second universal interface and information on the second sensor being input through the touch screen, matching and storing a second sensing value received through the second universal interface and the information input regarding the second sensor; and
alternately opening or closing a first fuel inlet valve for a first flow channel wherein the first sensor is arranged and a second fuel inlet valve for a second flow channel wherein the second sensor is arranged, and alternately using the first sensor and the second sensor.

13. The control method of claim 12, further comprising:
while operating in a first operation mode of using the first sensor, based on a sensing value of the first sensor being maintained within a specific numerical range during a predetermined time, automatically converting to a second operation mode of using the second sensor; and
while operating in the second operation mode, based on a sensing value of the second sensor changing to exceed a predetermined change rate, automatically converting to the first operation mode.

14. The control method of claim 13, further comprising:
while operating in the first operation mode, training an artificial intelligence learning model by using a first sensing value of the first sensor received through the first universal interface;
diagnosing a state of a system wherein the plurality of sensors are installed based on a change pattern of the first sensing value or the second sensing value and the artificial intelligence learning model; and
outputting the diagnosis result.

15. The control method of claim 13,
wherein the controlling the external valve comprises:
based on the first sensor and the second sensor being sensors of different types, while operating in the second operation mode, assuming the first sensing value based on association data between sensing items of the first sensor and the second sensor and the sensing value of the first sensor; and
controlling the external valve based on the assumed first sensing value.
